(19) United States
(12) Patent Application Publication
(10) Pub. No.: US 2012/0141220 A1
(43) Pub. Date: Jun. 7, 2012

(54) INNER COOLING CUTTER CHUCK

(76) Inventor: CHIN-CHIU CHEN, Cingshuei Chen (TW)

(21) Appl. No.: 12/962,350

(22) Filed: Dec. 7, 2010

(51) Int. Cl. B23C 5/28

(52) U.S. Cl. 409/136

(57) ABSTRACT

An inner cooling cutter chuck has a through hole, multiple first cooling passageways and a threaded section. The through hole of the inner cooling cutter chuck is axially formed through the inner cooling cutter chuck and has an inner surface. The first cooling passageways are formed in the inner cooling cutter chuck and communicate with the through hole of the inner cooling cutter chuck. The threaded section is formed around the inner surface of the through hole of the inner cooling cutter chuck. The first cooling passageways enable the inner cooling cutter chuck to contain more cooling liquid. Inner surfaces of the first cooling passageways can increase heat-dissipating areas inside the inner cooling cutter chuck. Accordingly, the first cooling passageways can enhance the cooling effect.

### BACKGROUND OF THE INVENTION

1. Field of the Invention

The present invention relates to a cutter chuck, and more particularly to an inner cooling cutter chuck to enhance a cooling effect.

2. Description of Related Art

A conventional cutter chuck allows a cutter to be mounted on and has a through hole axially formed through the cutter chuck. The through hole of the cutter chuck allows cooling liquid to flow toward the cutter for cooling and lubrication. The cooling liquid can cool the cutter chuck, the cutter, blades and a workpiece.

However, a cooling effect of the cutter chuck is not sufficient and the flowing speed of the cooling liquid in the through hole of the cutter chuck is not fast enough to dissipate more heat. Therefore, the conventional cutter chuck needs to be improved to enhance the cooling effect.

To overcome the shortcomings, the present invention tends to provide an inner cooling cutter chuck to mitigate the aforementioned problems.

### SUMMARY OF THE INVENTION

The main objective of the invention is to provide an inner cooling cutter chuck to enhance a cooling effect.

An inner cooling cutter chuck has a through hole, multiple first cooling passageways and a threaded section. The through hole of the inner cooling cutter chuck is axially formed through the inner cooling cutter chuck and has an inner surface. The first cooling passageways are formed in the inner cooling cutter chuck and communicate with the through hole of the inner cooling cutter chuck. The threaded section is formed around the inner surface of the through hole of the inner cooling cutter chuck. The first cooling passageways enable the inner cooling cutter chuck to contain more cooling liquid. Inner surfaces of the first cooling passageways can increase heat-dissipating areas inside the inner cooling cutter chuck. Accordingly, the first cooling passageways can enhance the cooling effect.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of a cutter connected with an inner cooling cutter chuck in accordance with the present invention;

FIG. 2 is an exploded perspective view of the cutter and the inner cooling cutter chuck in FIG. 1; and

FIG. 3 is a side view of the cutter and the inner cooling cutter chuck in FIG. 1.

### DETAILED DESCRIPTION OF PREFERRED EMBODIMENT

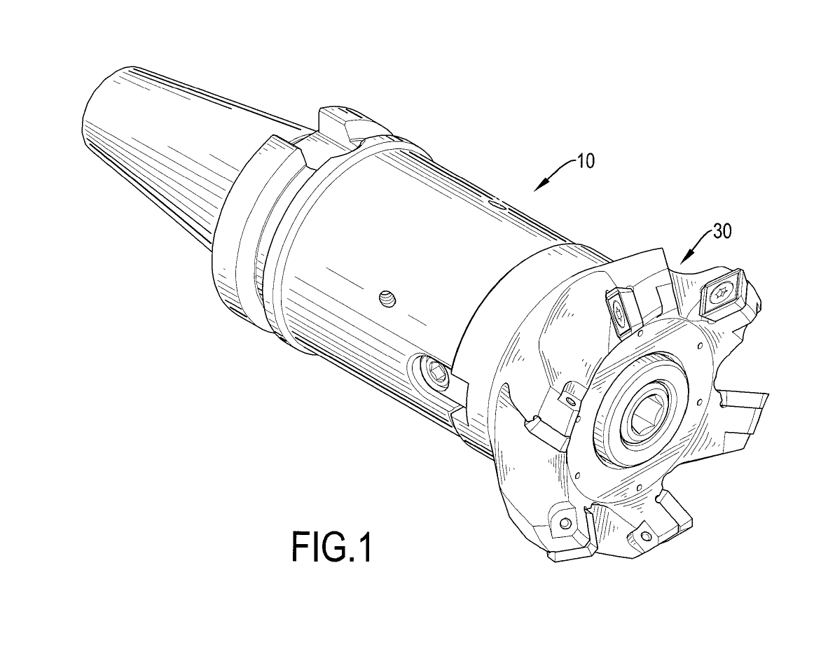

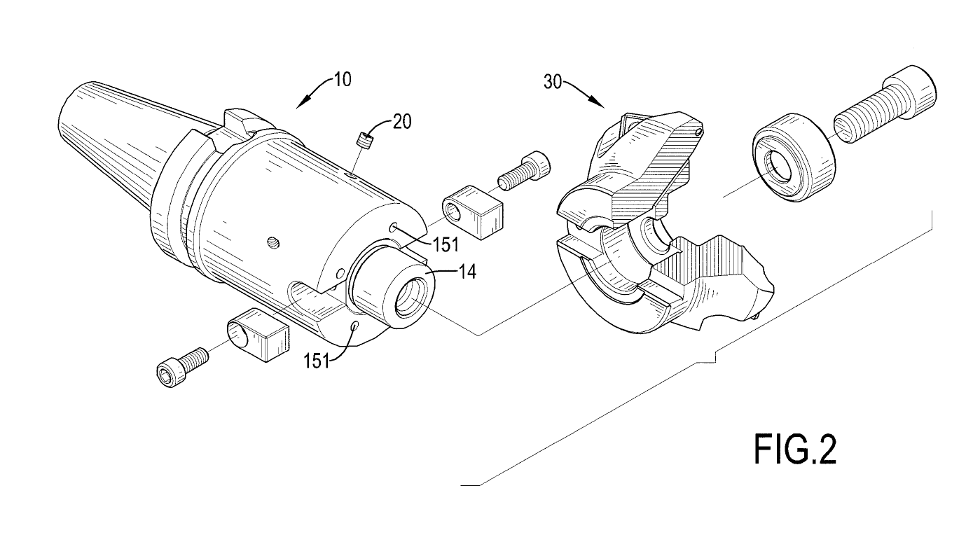

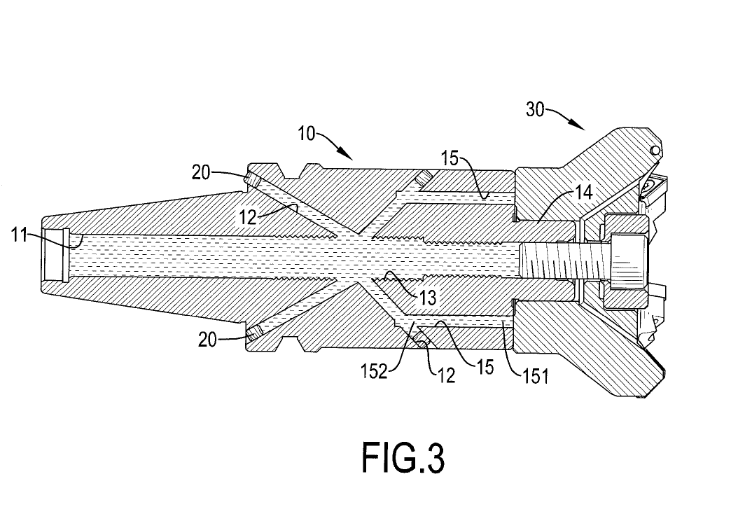

With reference to FIGS. 1 to 3, an inner cooling cutter chuck 10 in accordance with the present invention comprises an outer surface, an end surface, a through hole 11, multiple first cooling passageways 12, a threaded section 13, a connecting protrusion 14 and multiple second cooling passageways 15.

The through hole 11 of the cooling cutter chuck 10 is axially formed through the inner cooling cutter chuck 10 and has an inner surface.

The first cooling passageways 12 are formed in the inner cooling cutter chuck 10 for receiving cooling liquid and respectively communicate with the through hole 11 of the inner cooling cutter chuck 10. Preferably, each first cooling passageway 12 has a first opening, a second opening and an inner surface. The first openings of the first cooling passageways 12 are formed through the outer surface of the inner cooling cutter chuck 10. The second openings of the first cooling passageways 12 are formed through the inner surface of the through hole 11 of the inner cooling cutter chuck 10 to make the first cooling passageways 12 communicate with the through hole 11 of the inner cooling cutter chuck 10.

The threaded section 13 is formed around the inner surface of the through hole 11 of the inner cooling cutter chuck 10.

The connecting protrusion 14 is axially formed on and protrudes from the end surface of the inner cooling cutter chuck 10 and is inserted securely into a cutter 30.

Each second cooling passageway 15 has a first opening 151 and a second opening 152. The first openings 151 of the second cooling passageways 15 are formed through the end surface of the inner cooling cutter chuck 10 beside the connecting protrusion 14. The second openings 152 of the second cooling passageways 15 are formed through the inner surfaces of the first cooling passageways 12.

Multiple plugs 20 are implemented, are respectively mounted securely in the first cooling passageways 12 and are respectively adjacent to the first openings of the first cooling passageways 12. Preferably, each plug 20 is a bolt. Each plug may be a steel ball or a pin to prevent cooling liquid from leaking. The present invention does not limit the format of the plugs 20.

From the above description, it is noted that the present invention has the following advantages:

1. Enhanced Cooling Effect:

The first cooling passageways 12 enable the inner cooling cutter chuck 10 to contain more cooling liquid. Moreover, the inner surfaces of the first cooling passageways 12 can increase heat-dissipating areas inside the inner cooling cutter chuck 10. Accordingly, the first cooling passageways 12 can enhance the cooling effect.

2. Prolonged Life of the Inner Cooling Cutter Chuck 10:

The heat of the inner cooling cutter chuck 10 can be quickly dissipated via the first cooling passageways 12, so the heat of the cutter 30 and a workpiece can be dissipated quickly. The quick heat-dissipation facilitates to prolong life of the inner cooling cutter chuck 10 and lowers maintenance costs.

3. Quick Flowing Speed and Large Flow Rate of the Cooling Liquid

The threaded section 13 helps the cooling liquid flow quickly to increase the flow rate of the cooling liquid for quick heat-dissipation of the inner cooling cutter chuck 10.

4. Stable Rotation of the Inner Cooling Cutter Chuck 10:

The first cooling passageways 12 and the threaded section 13 increase the inner area of the inner cooling cutter chuck 10, so a damping area can be increased and a resonance decay effect can be enhanced to make the inner cooling cutter chuck 10 rotate stably.

5. Increased Centrifugal Effect:

The cooling liquid can be distributed evenly inside the inner cooling cutter chuck 10 via the first cooling passageways 12, and the centrifugal effect can be increased to remove fragments of the workpiece quicker.

6. Enhanced Processing Precision:

The stable rotation of the inner cooling cutter chuck 10 can enhance processing precision and reduce tolerances of the workpiece.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An inner cooling cutter chuck for holding a cutter thereon, the inner cooling cutter chuck comprising:
a through hole axially formed through the inner cooling cutter chuck and having an inner surface;
at least one first cooling passageway formed in the inner cooling cutter chuck and communicating with the through hole of the inner cooling cutter chuck; and
a threaded section formed around the inner surface of the through hole of the inner cooling cutter chuck.

2. The inner cooling cutter chuck as claimed in claim 1, wherein
the inner cooling cutter chuck has an outer surface;
multiple first cooling passageways are implemented;
each first cooling passageway has
a first opening formed through the outer surface of the inner cooling cutter chuck; and
a second opening formed through the inner surface of the through hole of the inner cooling cutter chuck; and
multiple plugs are further implemented, are respectively mounted securely in the first cooling passageways and are respectively adjacent to the first openings of the first cooling passageways.

3. The inner cooling cutter chuck as claimed in claim 2, wherein
the inner cooling cutter chuck has
an end surface;
a connecting protrusion axially formed on and protruding from the end surface of the inner cooling cutter chuck; and
multiple second cooling passageways, each has
a first opening formed through the end surface of the inner cooling cutter chuck beside the connecting protrusion; and
a second opening formed through an inner surface of one of the first cooling passageways.

4. The inner cooling cutter chuck as claimed in claim 2, wherein each plug is a bolt.

5. The inner cooling cutter chuck as claimed in claim 3, wherein each plug is a bolt.
